(19) United States
(12) Patent Application Publication
(10) Pub. No.: US 2012/0142819 A1
(43) Pub. Date: Jun. 7, 2012

(54) AQUEOUS EMULSION SHEAR STABLE COATING VEHICLE

(76) Inventors: Jamie Dziczkowski, Holly Springs, NC (US); Scott Cooley, Apex, NC (US); Robert S. DeRuiter, Cary, NC (US); Stephen R. Shearon, Raleigh, NC (US); Eric Cline, Raleigh, NC (US)

(21) Appl. No.: 13/300,980

(22) Filed: Nov. 21, 2011

Related U.S. Application Data
(60) Provisional application No. 61/419,990, filed on Dec. 6, 2010.

(51) Int. Cl. C09D 167/03; C08L 63/02; C08K 5/1515; C08K 5/10; C08K 5/17; C08K 5/07; C08L 67/03; C08K 5/06

(52) U.S. Cl. 523/402; 524/605; 524/591; 524/588; 524/377; 524/369; 524/315; 524/378; 524/249; 524/317; 524/221; 524/58; 524/114; 524/236

(57) ABSTRACT

The present invention provides an aqueous emulsion shear stable coating vehicle comprising a polyalkylene glycol modified alkyd resin. The alkyd resin may be modified by incorporating polyoxyalkylene glycol segments into the backbone of the alkyd resin. In one embodiment the alkyd resin is derived from the reaction of at least one natural oil and an acid and/or acid anhydride and polyhydric alcohol. The resulting shear stable coating vehicle can be combined with a pigment under high shear conditions to provide a paint composition.

### CROSS-REFERENCE TO RELATED APPLICATIONS

This application claims the benefit of, and incorporates herein by reference in its entirety, the following U.S. Provisional application: U.S. Provisional Application No. 61/419,990, filed Dec. 6, 2010.

### FIELD AND BACKGROUND OF THE INVENTION

The present invention relates to aqueous emulsions, and more particularly to a shear stable aqueous alkyd emulsion for use as a coating vehicle.

Traditionally, paints have been based on polymers in organic solvents. Such solvent-based materials were preferred because of their durability and fast dry properties. However, such solvent-based paints have become disfavored because the use of solvents are associated with volatile organic compound (VOC) levels and the attendant pollution concerns.

An alternative to such solvent-based materials has been waterborne polymers in particular waterborne alkyd emulsions. Such alkyds can be made using renewable resources and have substantially zero VOC levels. However, stable alkyd emulsions that perform comparably to solvent-based materials have been a challenge and solutions to improving stability have not been cost effective or have other problems such as slow cure time.

Existing alkyd emulsions also suffer when used in paint compositions that require certain levels of volume solids in the formulation. Direct grinding of the pigment into the resin is often required and is accomplished by using high shear conditions. If the alkyd resin is not able to withstand such shear conditions during the pigment grinding phase, the resin particles will agglomerate and result in a paint that exhibits instability.

Thus, there is a need to provide a coating vehicle that has low VOCs, is stable, and has improved shear stability.

### SUMMARY OF THE INVENTION

To this end, the present invention provides an aqueous emulsion shear stable coating vehicle comprising a polyalkylene glycol modified alkyd resin. The alkyd resin may be modified by incorporating polyoxyalkylene glycol segments into the backbone of the alkyd resin. In one embodiment the alkyd resin is derived from the reaction of at least one natural oil and an acid and/or acid anhydride and polyhydric alcohol. The resulting shear stable coating vehicle can be combined with a pigment under high shear conditions to provide a paint composition.

### DETAILED DESCRIPTION OF EMBODIMENTS OF THE INVENTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items. Furthermore, the term “about,” as used herein when referring to a measurable value such as an amount of a compound, dose, time, temperature, and the like, is meant to encompass variations of 20%, 10%, 5%, 1%, 0.5%, or even 0.1% of the specified amount.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this invention belongs.

The term “consists essentially of” (and grammatical variants), as applied to the methods in this invention, means the methods or compositions can contain additional steps as long as the additional steps or components do not materially alter the basic and novel characteristic(s) of the present invention.

The term “consisting of” excludes any additional step that is not specified in the claim.

Unless the context indicates otherwise, it is specifically intended that the various features of the invention described herein can be used in any combination.

Moreover, the present invention also contemplates that in some embodiments of the invention, any feature or combination of features set forth herein can be excluded or omitted.

All patents, patent applications and publications referred to herein are incorporated by reference in their entirety. In case of a conflict in terminology, the present specification is controlling.

As one of ordinary skill in the art may appreciate, the parameters described herein may vary greatly depending on the process, formulation and/or apparatus as well as the desired properties of the final product.

The present invention provides an aqueous emulsion shear stable coating vehicle comprising a polyoxyalkylene glycol modified alkyd resin. The term “alkyd resin” refers to a resin derived from the reaction of an alcohol and an acid or an acid anhydride. In some embodiments, the alkyd resin includes an alkyd that is derived from at least one anhydride and at least one polyhydric alcohol, and is modified/reacted with an unsaturated fatty acid, i.e., a synthetic or natural oil and fatty acids derived from such oils. Alternatively, non-fatty acid modified alkyds may be used.

The term “natural oil” refers to a triglyceride derived from a renewable resource, such as plant material. Exemplary natural oils include soy oil, corn oil, rapeseed oil, flax oil, castor oil, sunflower oil, tung oil, linseed oil, palm oil, cottonseed oil, canola oil, dehydrated castor oil, coconut oil, and the like, and blends thereof.

The term “polyalkylene glycol modified alkyd resin” refers to modifying the alkyd resin by incorporating polyoxyalkylene glycol segments into the backbone of the alkyd resin. Suitable polyoxyalkylene glycols are based on linear and branched polyalkylene glycols and include polyoxyethylene glycol, polyoxypropylene glycol, poly(tetramethylenether) glycol (polyTHF), and blends and mixtures thereof. The polyoxyalkylene glycol typically has a molecular weight of from 400 to 6000 and the polyoxyalkylene content is from about 0.5 to 20 percent of the molecule.

The acid and/or acid anhydride portion of the alkyd may be any diacid or monofunctional acid known in the art used in the formation of an alkyd resin. The dicarboxylic acid may be, for example, isophthalic acid, phthalic anhydride (acid), terephthalic acid, adipic acid, tetrachlorophthalic anhydride, dodecanedioic acid, sebacic acid, azelaic acid, 1,4-cyclohexanedicarboxylic acid, 1,3-cyclohexanedicarboxylic acid, maleic anhydride, fumaric acid, succinic anhydride, succinic acid, 2,6-naphthalenedicarboxylic acid, or glutaric acid and the like. In one embodiment, the dicarboxylic acid is isophthalic acid, phthalic anhydride, or phthalic acid. A monofunctional acid may also be used such as, for example, benzoic acid, acetic acid, propionic acid, and butanoic acid.

The polyhydric alcohol comprise alcohols having a-b hydroxyl groups per molecule including dihydric alcohols such as ethylene glycol, 1,2-propylene glycol, 2,3-butylene glycol, 1,4-butanediol, 1,5-pentanediol and 2,2-bis(4-hydroxycyclohexyl)propane; trihydric alcohols such as glycerine, 1,1,1-trimethylolethane, 1,1,1-trimethylolpropane, and 2,6-hexanetriol; tetrahydic alcohols such as erythritol, pentaerythritol and alpha-methyl glucoside; pentahydric and hexahydric alcohols such as tetramethylolcyclohexanol, dipentaerythritol, mannitol and sorbitol; polyallyl alcohol; and oxyalkylene adducts such as diethylene glycol, triethylene glycol and polyethylene glycol.

The alkyd resin can be chain extended in various ways known to those skilled in the art. The alkyd resin may be chain extended with an organic epoxy. The epoxy component that is employed in the invention may be selected from a number of epoxy compounds that are known in the art. For the purposes of the invention, the epoxy component may be selected from an epoxide resin, an epoxy diluent, an epoxy flexibilizer, and mixtures thereof. Preferably, the epoxy component has from about 1 to about 4 1,2-epoxy groups per molecule, and more preferably, from about 1.8 to about 3.5 1,2-epoxy groups per molecule.

The epoxy is preferably a glycidyl ether of a polyhydric phenol and polyhydric alcohol having an epoxide equivalent weight of from about 100 to about 500. Exemplary epoxies are the ones based on bisphenol-A and bisphenol-F, such as, but not limited to, the diglycidyl ether of bisphenol-A and the diglycidyl ether of bisphenol-F. Other epoxy resins include, but are not limited to, the diglycidyl ether of tetrabromobisphenol A, epoxy novolacs based on phenol-formaldehyde condensates, epoxy novolacs based on phenol-cresol condensates, epoxy novolacs based on phenol-dicyclopentadiene condensates, diglycidyl ether of hydrogenated bisphenol A, digylcidyl ether of resorcinol, tetraglycidyl ether of sorbitol, and tetra glycidyl ether of methylene dianiline. Mixtures of any of the above may be employed.

The alkyd resin may also be chain extended with an organic isocyanate including any known di- or polyisocyanates. Examples of isocyanates include polyisocyanates and diisocyanates known in the art such as diphenylmethane diisocyanate, 1,6-hexamethylene diisocyanate and 3,5-toluene diisocyanate. Particularly suitable di- and polyisocyanates have differing reactivity caused, for example, by stearic hindrance may be used, and include, for example, 2,4-toluene diisocyanate; mixtures of toluene diisocyanates having a majority of the species having differing activity, such as 80 percent 2,4-toluene diisocyanate and 20 percent 2,6-toluene diisocyanate by weight are also particularly suitable as is isophorone diisocyanate. Other polyisocyanates suitable for use in the present invention include diisocyanates, such as 2,6-toluene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenylmethane diisocyanate, 4,4′-diphenylmethane diisocyanate, 3,3′-dimethylphenylene diisocyanate, 4,4′-biphenylene diisocyanate, 1,6-hexane diisocyanate, isophorone diisocyanate, methylenebis(4-cyclohexyl)isocyanate, 2,2,4-trimethyl hexamethylene diisocyanate, bis(2-isocyanate-ethyl)fumarate, 6-isopropyl-1,3-phenyl diisocyanate, 4-diphenylpropane diisocyanate, lysine diisocyanate, hydrogenated diphenylmethane diisocyanate, hydrogenated xylylene diisocyanate, tetramethylxylylene diisocyanate, and 2,5 (or 6)-bis(isocyanatemethyl)-bicyclo[2.2.1]heptane. These diisocyanate compounds can be used either alone or in combination.

Alternatively, the alkyd resin can be chain extended with an organic silicon/silane. For example, a modified silane may be used and has the following formula:

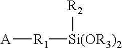

wherein A is an epoxy, isocyante or amino group to react with the alkyd functionality, R₁ is an alkyl group having 1 to 8 carbons; R₂ is selected from the group consisting of a lower alkyl and an alkoxy; and R₃ is a lower alkyl. The alkoxy of R₂ can be methoxy, ethoxy or propoxy. The lower alkyl can be methyl, ethyl, n-propyl, iso-propyl, n-butyl, iso-butyl, tert-butyl, and the like.

The alkyd resin may include nonionic, anionic, cationic, and amphoteric surfactants. Suitable nonionic surfactant include polyoxyalkylene alkyl ethers, polyoxyalkylene alkylphenyl ethers, polyoxyalkylene fatty acid esters, polyoxyethylene-polyoxypropylene alkyl ethers, polyoxyalkylene alkylamines, glycerol fatty acid esters, higher fatty acid alkanolamides, alkylglycosides, alkylglucosamides, alkylamine oxides, ethylene oxides, and the like, and mixtures thereof.

Suitable anionic surfactants include sodium alkyl aryl sulfonates, alkyl sulphonates, alkylpolyether sulphates, alkyl sulfates, fatty acid soaps, salts of hydroxy-, hydroperoxy-, polyhydroxy-, epoxy-fatty acids, salts of mono- and polycarboxylic acids, alkyl phosphates, alkyl phosphonates, sodium-dialkyl sufosuccinate, n-alkyl ethoxylated sulfates, perfluorocarboxylic acids, fluoroacliphatic phosphonates, fluoroaliphatic sulphates, and mixtures thereof. In particular embodiments, the anionic surfactant includes sodium dodecyl benzene sulfonate. Examples for suitable cationic surfactants include quaternary alkyl ammonium halides, phosphates, acetates, nitrates, sulfates; polyoxyalkyleneamines, poly(ethyleneoxide)amine, polyoxyalkylamine oxides, substituted imidazoline of alkyl fatty acids, alkylbenzyldimethylammonium halides, and alkyl pyridinium halides. Examples for suitable amphoteric surfactants include imidiazolinederived amphoterics, other carboxybetaines, sulfatobetaines, sulfitobetaines, sulfobetaines, phosphon-iobetaines, N-alkylamino acids and the like.

The shear stable coating vehicle may be combined with a pigment to provide a paint composition. Any suitable pigments may be used, including, but not limited to, bright pigments such as aluminum powder, copper powder, nickel powder, stainless steel powder, chromium powder, micaceous iron oxide, titanium dioxide-coated mica powder, iron oxide-coated mica powder and bright graphite; organic red pigments such as Pink EB, azo- and quinacridone-derived pigments; organic blue pigments such as cyanin blue and cyanin green; organic yellow pigments such as benzimidazolone-, isoindolin- and quinophthalone-derived pigments; inorganic colored pigments such as titanium white, titanium yellow, iron red, carbon black, chrome yellow, iron oxide, various calcined pigments, and mixtures thereof.

According to other embodiments of the invention, the paint compositions may be applied to a substrate by any method known to those of skill in the art, such as spraying, rolling, knife-coating, pouring, brushing or dipping.

Coagulants may be included. For example, the alkyd resin may include ammonia, ammonium hydroxide, and primary, secondary and tertiary mono- or polyamines, including hydroxyamines, and especially the lower alkylamines, such as ethylamine, butylamine, dimethyl amine, diethyl amine, tributyl amine, triethyl amine, triisopropanolamine, ethanolamine, dimethylethanolamine, butanolamine, and the like. Amines which are volatile at temperatures below 350° F., preferably 250° F., are preferred and are described, for example, in U.S. Pat. No. 4,374,720. Alternatively, polyethylene imines such as described in U.S. Pat. No. 6,376,574 may be used. The amines or imines can be added in undiluted form with a neutralizing agent to give essentially anhydrous neutralized resin products, which products will be capable of practically unlimited dilution or dispersion in water without being coagulated. Suitable neutralizing agents, include ammonia, ammonium hydroxide, potassium or sodium hydroxide or carbonates can also be used. Mixtures of neutralizing agents can also be used.

The emulsions of the invention can provide alkyd resins in the form of emulsion droplets having an average diameter of less than 3000 nm, and frequently less than 500 nm. The present invention provides an alkyd emulsion that has a lower acid value, i.e., below 15, higher solids content, i.e., above 40 percent, and a particle size of 50 nm or greater.

The emulsions can be made into waterborne paints or coatings by mixing with the pigment. This very well known method by those skilled in the art—often called “letdown”—is typically carried out under gentle agitation. The success of the letdown step depends on achieving an intimate intermingling of these two disparate particle systems to yield a stable and uniform overall particle suspension (the alkyd-based paint) and the emulsions of this invention can be effectively used in such systems.

If desired and depending on the intended use of the paint composition, additional components may be added to the composition. These additional components include but are not limited to thickeners; rheology modifiers; dyes; sequestering agents; biocides; dispersants; extenders, such as, calcium carbonate, talc, clays, silicas and silicates; fillers, such as, glass or polymeric microspheres, quartz and sand; anti-freeze agents; plasticizers; adhesion promoters; coalescents; wetting agents; waxes; surfactants; slip additives; crosslinking agents; defoamers; colorants; preservatives; freeze/thaw protectors, corrosion inhibitors; and alkali or water soluble polymers.

The present invention will now be described in more detail with reference to the following examples. However, these examples are given for the purpose of illustration and are not to be construed as limiting the scope of the invention.

### EXAMPLES

The alkyd resins were synthesized using the monoglyceride process. During the alcoholysis or transesterification stage, the oil, part or all of the polyhydric alcohol, polyoxyalkylene glycol and the alcoholysis catalyst were added to the reactor and heated to alcoholysis temperature. Once top heat was reached, the temperature was maintained for one hour then checked for solubility in hot methanol (1 part resin to 3 parts MeOH). Following completion of the alcoholysis stage, the remainder of the polyhydric alcohol, monobasic acid, and the dibasic acid were added. The reactor contents were then slowly heated to an esterification reaction temperature and held at constant temperature until an acid value of 8-10 mg KOH/g sample was obtained. Table 1 gives the different alkyd compositions and alkyd resin wet properties.

The alkyd resins were then emulsified using external surfactants. Examples 1-3 illustrate the use of external and internal surfactants to obtain stable alkyd emulsions. After emulsification was complete, particle size, pH, and solids content were measured and recorded. Alkyd Resins 1-3 comprises soybean oil, pentaethryitol, polyethylene oxide (MW=3350), the monobasic acid is benzoic acid and the dibasic acid anhydride is phthalic anhydride. Table 2 gives the alkyd emulsion wet properties.

### Example 1

| Material | Weight (g) |
|---|---|
| Alkyd Resin 1 | 250.0 |
| Non-ionic surfactant (ethylene oxide/propylene | 15.0 |
| oxide copolymer) | |
| Anionic surfactant (sodium dodecylbenzene | 3.75 |
| sulfonate) | |
| Oil-based Defoamer | 0.20 |
| Neutralizing base (ammonium hydroxide) | 3.80 |
| Deionized water | 217 |

### Example 2

| Material | Weight (g) |
|---|---|
| Alkyd Resin 2 | 250.0 |
| Non-ionic surfactant | 8.75 |
| Anionic surfactant | 3.75 |
| Oil-based Defoamer | 0.20 |
| Neutralizing base | 4.10 |
| Deionized water | 258.5 |

### Example 3

| Material | Weight (g) |
|---|---|
| Alkyd Resin 3 | 250.0 |
| Non-ionic surfactant | 5.63 |
| Anionic surfactant | 3.75 |
| Oil-based Defoamer | 0.20 |
| Neutralizing base | 4.10 |
| Deionized water | 255 |

TABLE 1
Polyoxyalkylene glycol modified alkyd resins.
PAG Modified Alkyds
Alkyd Resin Formulation

| | Alkyd 1 | Alkyd 2 | Alkyd 3 |
|---|---|---|---|
| Material | Weight (g) | Weight (g) | Weight (g) |
| Soy Oil | 746.70 | 746.70 | 746.70 |
| Pentaerythritol | 226.82 | 223.57 | 218.00 |
| Polyethylene Glycol (MW = 3350) | 53.00 | 73.00 | 113.00 |
| Lithium neodecanoate (2%) | 1.86 | 1.87 | 1.87 |
| Pentaerythritol | 226.82 | 223.57 | 218.00 |
| Benzoic Acid | 297.08 | 287.07 | 262.86 |
| Phthalic Anhydride | 541.96 | 536.31 | 526.94 |

Resin Wet Properties

| | I | | II |
|---|---|---|---|
| Viscosity at 60NV in xylene | X-5/15.3 | Y-2/18.8 | X-0/13.0 |
| (G-H/stokes) | | | |
| Acid Value | 10.1 | 10.3 | 9.4 |
| Color at 60NV in xylene | 3− | 3+ | 3− |

TABLE 2
PAG modified alkyd resin emulsion properties
Alkyd Emulsion Wet Properties

| | Alkyd 1 | Alkyd 2 | Alkyd 3 |
|---|---|---|---|
| | Emulsion | Emulsion | Emulsion |
| Solids, % | 54.5 | 51.1 | 50.5 |
| pH | 7.1 | 7.8 | 8.5 |
| Particle Size, nm | | | |
| mv | 217.9 | 251.9 | 179.9 |
| mn | 137.5 | 156.4 | 98.5 |
| Distribution | 1.6 | 1.6 | 1.8 |

After the alkyd resin emulsions were achieved, the resins were chain-extended by the reaction of organic isocyanate with the emulsion. Example 4 gives a sample chain extension formulation.

### Example 4

| Material | Weight (g) |
|---|---|
| Alkyd Resin 1 Emulsion | 589.5 |
| Catalyst | 0.1 |
| Oil-based Defoamer | 0.1 |
| Diisocyanate | 26.22 |
| Deionized water | 15.42 |

The shear stability of the alkyd resin emulsions was measured by taking 150 grams of material and placing it on a commercial waring blender for 10 minutes. The particle size was measured before and after exposure to the high shear conditions. An observed trend of an increase of 100% or less of the initial particle size generally shows shear stability during pigment grinding. Table 3 gives shear stability screening data of a PAG modified alkyd versus current commercially available alkyd emulsions wherein Commercial Alkyd Emulsion 1 is Beckosol®AQ 206 and Commercial Alkyd Emulsion 2 is Uradil XP 7600.

TABLE 3
Shear stability data of PAG modified alkyd resin
emulsions vs. commercial alkyd resin emulsions
Shear Stability Data

| | Commercial | Commercial | PAG Modified Chain |
|---|---|---|---|
| | Alkyd | Alkyd | Extended Alkyd |
| | Emulsion 1 | Emulsion 2 | Emulsion |
| Particle Size, | | | |
| Initial (nm) | | | |
| Dv | 232.2 | 334.1 | 210.5 |
| Particle Size, | | | |
| After Shear (nm) | | | |
| Dv | 715.3 | 1115 | 324.4 |

Paint formulations at high volume solids (>60%) were made with a commercially available alkyd resin emulsion and a PAG modified alkyd resin emulsion. The paint formulas and paint wet properties are provided in Table 4.

TABLE 4
High volume solids paint formulations of PAG modified alkyd
resin emulsion as compared to commercial alkyd resin emulsion
#/100 Gallon Formula

| | PAG modified | Commercial |
|---|---|---|
| | alkyd emulsion | alkyd |
| | Weight (g) | emulsion 1 |
| Raw Material | | |
| PAG Modified Alkyd | 460.03 | — |
| Commercial Alkyd | 0.00 | 439.19 |
| Emulsion 1 | | |
| Water | 74.49 | 105.08 |
| Pigment Dispersant | 6.69 | 6.20 |
| Surfactant | 2.56 | 2.38 |
| Defoamer | 1.00 | 0.85 |
| Pigment | 91.58 | 84.90 |
| Pigment Filler | 759.62 | 760.01 |
| Cobalt Additive | 2.53 | 2.42 |
| Zirconium additive | 3.16 | 3.02 |
| Defoamer | 2.00 | 1.70 |
| Rheology Modifier | 1.04 | 0.00 |
| Total | 1404.69 | 1405.74 |
| Paint Analysis | | |
| P:B by Weight | 3.36 | 3.50 |
| PVC, % | 57.0 | 58.4 |
| VOC, #/gal | 0.07 | 0.12 |
| VOC, g/l | 7.87 | 14.14 |
| NV, Weight | 0.79 | 0.78 |
| NV, Volume | 0.65 | 0.63 |
| WPG | 14.05 | 14.06 |
| Wet Properties | | |
| Viscosity, KU | 97.2 | Coagulated during grind |
| Viscosity, ICl | 2.100 | Coagulated during grind |
| pH | 7.48 | Coagulated during grind |

Clearly undesirable coagulation occurred in the commercial alkyd resin emulsion sample.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

1. An aqueous emulsion shear stable coating vehicle comprising an alkyd resin derived from the reaction of at least one natural oil and an acid and/or acid anhydride and polyhydric alcohol wherein polyalkylene glycol segments are incorporated into the alkyd resin backbone.

2. The aqueous emulsion shear stable coating vehicle of claim 1 wherein the alkyd resin comprises 0.5 to 20 percent by weight polyoxyalkylene glycol.

3. The aqueous emulsion shear stable coating vehicle of claim 2, wherein the natural oil comprises a plant triglyceride selected from the group consisting of soy oil, corn oil, rapeseed oil, flax oil, castor oil, sunflower oil, tung oil, linseed oil, palm oil, cottonseed oil, canola oil, dehydrated castor oil, coconut oil, and blends thereof.

4. The aqueous emulsion shear stable coating vehicle of claim 1, wherein the natural oil is soybean oil, the acid and/or acid anhydride is benzoyl acid and phthalic anhydride and the polyhydric alcohol is pentaerythritol.

5. The aqueous emulsion shear stable coating vehicle of claim 1 further comprising a non-ionic surfactant, an anionic surfactant, a cationic surfactant, and/or an amphoteric surfactant.

6. The aqueous emulsion shear stable coating vehicle of claim 5, wherein the non-ionic surfactant is selected from the group consisting of polyoxyalkylene alkyl ethers, polyoxyalkylene alkylphenyl ethers, polyoxyalkylene fatty acid esters, polyoxyethylene-polyoxypropylene alkyl ethers, polyoxyalkylene alkylamines, glycerol fatty acid esters, higher fatty acid alkanolamides, alkylglycosides, alkylglucosamides, alkylamine oxides, ethylene oxides and the anionic surfactant is selected from the group consisting of a sodium alkyl aryl sulfonates, alkyl sulphonates, alkylpolyether sulphates, alkyl sulfates, fatty acid soaps, salts of hydroxy-, hydroperoxy-, polyhydroxy-, epoxy-fatty acids, salts of mono- and polycarboxylic acids, alkyl phosphates, alkyl phosphonates, sodium-dialkyl sufosuccinate, n-alkyl ethoxylated sulfates, perfluorocarboxylic acids, fluoroacliphatic phosphonates, fluoroaliphatic sulphates, and mixtures thereof.

7. The aqueous emulsion shear stable coating vehicle of claim 1 further comprising chain extending the alkyd resin with an organic isocyanate.

8. The aqueous emulsion shear stable coating vehicle of claim 7, wherein the organic isocyanate is selected from the group consisting of 2,6-toluene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenylmethane diisocyanate, 4,4′-diphenylmethane diisocyanate, 3,3′-dimethylphenylene diisocyanate, 4,4′-biphenylene diisocyanate, 1,6-hexane diisocyanate, isophorone diisocyanate, methylenebis(4-cyclohexyl)isocyanate, 2,2,4-trimethyl hexamethylene diisocyanate, bis(2-isocyanate-ethyl)fumarate, 6-isopropyl-1,3-phenyl diisocyanate, 4-diphenylpropane diisocyanate, lysine diisocyanate, hydrogenated diphenylmethane diisocyanate, hydrogenated xylylene diisocyanate, tetramethylxylylene diisocyanate, and 2,5 (or 6)-bis(isocyanatemethyl)-bicyclo[2.2.1]heptane, and diisophorone diisocyanate, and blends and copolymers thereof.

9. The aqueous emulsion shear stable coating vehicle of claim 1 further comprising chain extending the alkyd resin with an organic silicone/silane.

10. The aqueous emulsion shear stable coating vehicle of claim 1 further comprising chain extending the alkyd resin with an organic epoxy resin.

11. The aqueous emulsion shear stable coating vehicle of claim 10, wherein the organic epoxy resin is diglycidol ether of bisphenol A.

12. The aqueous emulsion shear stable coating vehicle of claim 1 further comprising a coagulant and a neutralizing agent.

13. The aqueous emulsion shear stable coating vehicle of claim 1 having an acid value less than 15, a solids content above 40 percent, and a particle size of 50 nm or greater.

14. A paint composition that does not coagulate during pigment grind conditions, the paint composition consisting of the aqueous emulsion shear stable coating vehicle and a pigment, wherein the aqueous emulsion shear stable coating comprises an alkyd resin derived from the reaction of at least one natural oil and an acid and/or acid anhydride and polyhydric alcohol wherein polyalkylene glycol segments are incorporated into the alkyd resin backbone.

15. The paint composition of claim 14 comprising an alkyd resin derived from the reaction of at least one natural oil and an acid and/or acid anhydride and polyhydric alcohol wherein polyalkylene glycol segments are incorporated into the alkyd resin backbone.

16. The paint composition of claim 14 wherein the alkyd resin comprises 0.5 to 20 percent by weight polyoxyalkylene glycol.

17. The paint composition of claim 14, wherein the natural oil comprises a plant triglyceride selected from the group consisting of soy oil, corn oil, rapeseed oil, flax oil, castor oil, sunflower oil, tung oil, linseed oil, palm oil, cottonseed oil, canola oil, dehydrated castor oil, coconut oil, and blends thereof.

18. The paint composition of claim 14, wherein the natural oil is soybean oil, the acid and/or acid anhydride is benzoyl acid and phthalic anhydride and the polyhydric alcohol is pentaerythritol.

19. The paint composition of claim 14 further comprising a non-ionic surfactant, an anionic surfactant, a cationic surfactant, and/or an amphoteric surfactant.

20. The paint composition of claim 14, wherein the non-ionic surfactant is selected from the group consisting of polyoxyalkylene alkyl ethers, polyoxyalkylene alkylphenyl ethers, polyoxyalkylene fatty acid esters, polyoxyethylene-polyoxypropylene alkyl ethers, polyoxyalkylene alkylamines, glycerol fatty acid esters, higher fatty acid alkanolamides, alkylglycosides, alkylglucosamides, alkylamine oxides, ethylene oxides and the anionic surfactant is selected from the group consisting of a sodium alkyl aryl sulfonates, alkyl sulphonates, alkylpolyether sulphates, alkyl sulfates, fatty acid soaps, salts of hydroxy-, hydroperoxy-, polyhydroxy-, epoxy-fatty acids, salts of mono- and polycarboxylic acids, alkyl phosphates, alkyl phosphonates, sodium-dialkyl sufosuccinate, n-alkyl ethoxylated sulfates, perfluorocarboxylic acids, fluoroacliphatic phosphonates, fluoroaliphatic sulphates, and mixtures thereof.

21. The paint composition of claim 14 further comprising chain extending the alkyd resin with an organic isocyanate.

22. The paint composition of claim 14, wherein the organic isocyanate is selected from the group consisting of 2,6-toluene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenylmethane diisocyanate, 4,4′-diphenylmethane diisocyanate, 3,3′-dimethylphenylene diisocyanate, 4,4′-biphenylene diisocyanate, 1,6-hexane diisocyanate, isophorone diisocyanate, methylenebis(4-cyclohexyl)isocyanate, 2,2,4-trimethyl hexamethylene diisocyanate, bis(2-isocyanate-ethyl)fumarate, 6-isopropyl-1,3-phenyl diisocyanate, 4-diphenylpropane diisocyanate, lysine diisocyanate, hydrogenated diphenylmethane diisocyanate, hydrogenated xylylene diisocyanate, tetramethylxylylene diisocyanate, and 2,5 (or 6)-bis(isocyanatemethyl)-bicyclo[2.2.1]heptane, and diisophorone diisocyanate, and blends and copolymers thereof.

23. The paint composition of claim 14 further comprising chain extending the alkyd resin with an organic silicone/silane.

24. The paint composition of claim 14 further comprising chain extending the alkyd resin with an organic epoxy resin.

25. The paint composition of claim 14, wherein the organic epoxy resin is diglycidol ether of bisphenol A.

26. The paint composition of claim 14 further comprising a coagulant and a neutralizing agent.

27. The paint composition of claim 14 having an acid value less than 15, a solids content above 40 percent, and a particle size of 50 nm or greater.
